(19) United States
(12) Patent Application Publication
(10) Pub. No.: US 2005/0114681 A1
(43) Pub. Date: May 26, 2005

(54) Verifier

(76) Inventor: Peter Alden Greenlaw, Columbia, SC (US)

Correspondence Address: PG CONSULTING INC., 2000 CLEMSON RD #6, SUITE 220, COLUMBIA, SC, 29229, US

(21) Appl. No.: 10/707,115

(22) Filed: Nov. 21, 2003

(51) Int. Cl. H04K 1/00

(52) U.S. Cl. 713/186

(57) ABSTRACT

This concept has been developed without any assistance, or coaching, or involvement from any company or individual. The foregoing description of the embodiments of the invention has been presented for the purposes of illustration and description. It is not intended to be exhaustive or to limit the invention to the precise form disclosed. Many modifications and variations are possible.

### BACKGROUND OF INVENTION

With the advent of solid state memory to store information external to any type of mechanical drives or computer the Verifier is unique in its capabilities. There is no external power supply needed to store information, the thumbprint reader is verified by the power obtained from the USB port and compared to internal data in the solid state memory device. Once verification is complete the programs contained on the solid state memory will automatically execute to configure the PC for this user. The verification process can be further enhanced to include additional biometric information, face and voice recognition, using internal stored data for comparison. The Verifier can also be configured, once activated, to restrict access to allow only certain services to run. This is ideal for use in the family environment, restricting children to certain services.

### SUMMARY OF INVENTION

A solid state memory integrated with a biometric reader, specifically thumbprint. The thumbprint ID is to activate the solid-state memory not the computer, the computer merely recognizes the drive once verification of the thumbprint ID is complete. Once that is complete the computer is restricted to use only the resources designated from the input of the solid-state data

### DETAILED DESCRIPTION

The verifier is comprised of two products integrated to act as single unit. The marriage of the solid state memory and the fingerprint reader into a single product along with the addition of the appropriate software will incorporate a complete security system, and positive verification of the user.

The use of solid state memory and fingerprint identification are not new but the use of both of these items as a single product is an entirely new concept. The fingerprint reader will have more meaning than just scan and verification of the fingerprint. The biometric reader will be held between the thumb and forefinger and inserted into a USB extension attached to a convenient site (side of the monitor). The plugging in of the device will only activate the biometric reader, comparing this input to the fingerprint stored in the solid-state memory. Once this is complete the software will allow further access to the solid state memory. A large array of additional security measures can be employed from this point. Photo ID can be stored on the solid state memory and then verified via camera. Samples of voice can be compared and verified by microphone. These additional security measures could be instituted to preclude anyone else from getting the data and using it inappropriately. This product will change the concept of security to a simple plug and play.

This product would be used for all different types of computer logon. Parents could generate a key for their children that would only give them the restricted access to the internet without worry of the security measures being compromised. All the information required by various systems would be kept on the solid state memory the individual user will only be required to have their thumbprint. The Verifier can be transported and used on any computer that has a USB port.

1. A biometric reader activated by holding the thumb on the reader and plugging into a USB port. This data would be compared to data stored in the solid state memory not the computer, the computer merely recognizes the drive once verification of the fingerprint ID is complete. Once that is complete the computer is restricted to use only the resources designated from the input of the solid state data.

2. This device (The Verifier) acts as a physical and electronic key, a place where strong encrypted passwords can be generated and stored without the user having to remember them.

3. This device precludes the possibility of someone using a found key. Without the initial thumbprint no data can be accessed.
The software can be programmed to overwrite all data on The Verifier if access is attempted by an inappropriate bio-scan.

4. Additional storage area on the solid state memory can be used for sensitive data that is encrypted along with all the other data on the solid state memory.
